(19) United States
(12) Patent Application Publication
(10) Pub. No.: US 2022/0005020 A1
(43) Pub. Date: Jan. 6, 2022

(54) Peer-To-Peer Transfer of a Stored Value

(71) Applicant: Square, Inc., San Francisco, CA (US)

(72) Inventors: Dustin Moring, San Francisco, CA (US); Brandon Jacoby, San Francisco, CA (US); Benjamin Shen, San Francisco, CA (US); Owen Jennings, San Francisco, CA (US); Chun Wah Wu, San Francisco, CA (US)

(21) Appl. No.: 16/921,753

(22) Filed: Jul. 6, 2020

(51) Int. Cl. G06Q 20/34; G06F 16/23; G06Q 20/08; G06Q 20/32; G06Q 20/22

(52) U.S. Cl. CPC G06Q 20/342; G06F 16/2379; G06Q 20/227; G06Q 20/326; G06Q 20/085

(57) ABSTRACT

The present technology reduces external communication, server demand, network congestion, and processing power in facilitating the transfer of stored values. The technology as disclosed herein provides for users to transmit a stored value therebetween, allowing recipients to select how they would like to receive the stored value by means of one or more digital assets or other alternate values. The technology provides for a first user to transmit a stored value to one or more recipients. Upon receiving a selection as to how the recipients would like to receive the stored value, the present technology converts from the stored value as sent by the first user to the one or more alternate values as indicated by the recipients.

### BACKGROUND

Purchasing and delivering a gift for a friend or loved one tends to intimidate many people, especially when deciding on what to purchase. It is common to avoid asking the recipient directly what he/she would like in order to maintain the element of surprise or to alleviate the recipient from the burden of explaining exactly what they would like. Without asking directly, it is difficult to ascertain the optimum value or which type of good, or service the recipient may prefer, or the best mechanism for delivering the gift. Some people rely on giving a recipient a gift card in order to provide the recipient with some flexibility on what they can purchase from a particular merchant given a stored value associated with the gift card. However, gift cards are generally still limited to a specific merchant or website, must be redeemed or delivered in a particular manner, and not personalized for a particular recipient.

### BRIEF DESCRIPTION OF THE DRAWINGS

The above-recited and other advantages and features of the present technology will become apparent by reference to specific implementations illustrated in the appended drawings. A person of ordinary skill in the art will understand that these drawings only show some examples of the present technology and would not limit the scope of the present technology to these examples. Furthermore, the skilled artisan will appreciate the principles of the present technology as described and explained with additional specificity and detail through the use of the accompanying drawings in which:

FIG. 1 illustrates a payment service network according to one example as described herein.

FIG. 2 illustrates a data store framework of a payment service network according to one example as described herein.

FIG. 3 illustrates a mobile device and payment application according to one example as described herein.

FIG. 4A illustrates a method for transferring a stored value according to one example as described herein.

FIG. 4B illustrates a method for transferring a stored value according to one example as described herein.

FIG. 5A illustrates a graphical user interface for notifying a user of a received value according to one example as described herein.

FIG. 5B illustrates a graphical user interface for displaying a received value to a user according to one example as described herein.

FIG. 5C illustrates a graphical user interface for receiving an asset selection from a user according to one example as described herein.

FIG. 5D illustrates a graphical user interface for receiving details associated with an asset selection according to one example as described herein.

FIG. 6 illustrates a flow chart of a payment service process for transferring a stored value according to one example as described herein.

### DETAILED DESCRIPTION

Various examples of the present technology are discussed in detail below. While specific implementations are discussed, it should be understood that this is done for illustration purposes only. A person skilled in the relevant art will recognize that other components and configurations may be used without parting from the spirit and scope of the present technology.

The disclosed technology provides an improved process in transmitting stored values between user accounts. Specifically, the disclosed technology provides for a user to transmit a stored value to a recipient using a payment service, allowing the stored value to be received as a digital asset and selected asset fulfillment by the recipient. When receiving a stored value from a user, a recipient may be intelligently presented with digital asset options to receive the stored value based on the recipient's transaction activity or other purchase behavior conducted on the payment service. Specifically, the payment service described herein includes an internal ledger and data structure to facilitate purchasing a stored value (e.g., a gift card) from a sender device, allowing a user to transmit the stored value to a recipient, while the recipient has the ability to select a digital asset in which to receive or immediately convert the stored value. The digital asset may include merchant credits, merchant discounts, product discounts, services discounts, equities (or portions thereof), cryptocurrencies, fiat currencies, as well as combinations thereof, among others.

Prior gift systems suffer from technical shortcomings. For example, in prior gift systems, after a gift giver can send a digital gift, the gift system is limited to redemption and fulfillment options that only allow the intended recipient to accept the gift in the same form and value as given by the gift giver (e.g., accept a gift card of a certain value, accept a cash value, etc.) With the present system, the intended recipient can simply select an alternate gift (e.g., digital asset) before the present system reconciles the gift giver and recipient's accounts with the transaction, according to one example. The present system is able to intelligently present recommended fulfillment options and alternative types of gifts that are personalized to the recipient based on known transactions occurring on the payment service and accessible through the mobile applications executing on the gift giver and recipient's mobile devices.

The present payment service provides a universal method for a user to gift or otherwise transmit a stored value to a recipient without determining how the recipient should use the stored value. For example, a user may obtain and transmit a generic stored value to the recipient that can be reallocated and converted to one or more specific digital assets using the ledger architecture of the payment service.

If a recipient receives a gift card to a particular merchant at which they do not shop, there is a higher chance that the value of the gift card will go unused. Furthermore, even if a portion of the gift card is used by the recipient, any value left may not be used and still creates wasted value. This wasted value may incur storage loss and account maintenance costs by the data structures storing such value. The present technology eliminates such issues by providing to a recipient the full stored value as gifted by the user and allowing the recipient to decide how to use the value by mapping purchase activity to the most optimum digital assets. By providing a recipient with their preferred choice of gift card or digital asset, the received value has a lower risk of going unused and, therefore, improves the storage and efficiency of the data structure storing such value. As such, the present technology can transmit a stored value with increased efficacy through intelligent conversion of the stored value to a digital asset most likely to be used and of value to the recipient.

The present technology through the use of a payment service can further minimize network congestion when a user browses gift options before purchasing a gift, especially if the user does not know what the recipient wishes to receive. The payment service may generate digital asset recommendations catered to the intended recipient's preferences or other data associated with the recipient. Specifically, a user may be presented with digital asset recommendations generated by the payment service for the intended recipient. Alternatively, when a user transmits a stored value to a recipient, the payment service may generate digital asset recommendations to be selected by the recipient herself/himself. According to some examples, the payment service may generate and maintain a preference profile/model and leverage machine learning models based on the recipient's purchase history, transaction activity, location data, or other data associated with or stored in the recipient's user account to make intelligent digital asset recommendations. Preference profiles may be developed and/or updated by the payment service using training algorithms such as pattern recognition, deep learning, neural networks, and other statistical data analyses, among others. For example, a recipient may be presented with a digital asset recommendation that is associated with the merchant or a group of merchants most often shopped or visited by the intended recipient as indicated in their transaction activity and the transaction activity of other users that have a similar profile as the intended recipient.

According to some examples, preference profiles may include preference models developed and/or updated by the payment service using machine learning methods, such as Bayesian networks, regression models, as well as deep learning and artificial neural networks, among others. According to some examples, the training of preference models may be implemented by a machine learning module as provided by the payment service. As another example, a recipient may be presented with a digital asset recommendation that is predicted by the recipient's preference model to match the preferences of the recipient.

For example, if a recipient's transaction activity indicates that they frequent a particular merchant, the payment service may provide a digital asset recommendation including equity or fractional equity in that particular merchant. Similarly, transaction activity indicating purchases of a particular cryptocurrency (e.g., Bitcoin) using the payment service may generate digital asset recommendations including that particular cryptocurrency (e.g., 0.3 BTC). Further still, a recipient's transaction activity may indicate a particular category of merchants (e.g., similar to Merchant Category Codes, among others) frequented by the recipient. For example, a recipient may often shop at luxury brands and may receive a digital asset recommendation including credit to a luxury merchant (e.g., Gucci), or a combination of merchant credit and stock interest in the publicly trading company associated with the merchant.

The payment service may further provide digital asset recommendations to a user based on location data provided by a payment application executing on the user's mobile device, the user's transaction activity, or other data associated with the user. For example, if a user's location data indicates that the user is in a location identified by the payment service as a merchant associated with a digital asset recommendation, the user may receive a notification from the payment service suggesting a digital asset recommendation associated with the merchant.

The payment service may also permit a user to purchase an item without receiving a digital asset recommendation. A payment application provided by the payment service may allow a user to scan an item identifier using the user's own mobile device. According to some examples, item identifiers may be scanned by the payment application using visual codes (e.g., barcode, QR code, and the like), as well as codes transmitted by wireless communication protocols (e.g., near-field communication (NFC), Bluetooth, and the like), among others. Visual codes may be scanned by a camera of a user's mobile device, while codes transmitted by wireless communication protocols may be scanned by a wireless module of the user's mobile device. Upon scanning the item identifier, the payment application may initiate a purchase of the associated item and transmit an indication of the item to the recipient. For example, a user strolling the aisles of a merchant may be able to use a payment application provided by the payment platform to scan a barcode of a merchant gift card with the camera of the user's mobile device. Upon scanning, the payment application may purchase the gift card through the payment service and transmit an indication of the merchant gift card to a recipient indicated by the user.

The payment service may intentionally provide a delayed reconciliation between the purchase of gift (e.g., purchased item, digital asset, or other value) and the acceptance of the gift by the recipient. The delayed reconciliation may give the second user an opportunity to select or otherwise exchange the gift for something else. The delayed reconciliation may include a predetermined time threshold that when reached, triggers an acceptance of the gift by the recipient and transfer of value from the senders account to the recipients account, according to some examples.

During the period of delayed reconciliation, the gift may undergo a change in value overtime. For example, if a user transmits an equity or other tradeable security as a gift to a recipient, the value of the equity may change in value before the recipient claims the gift or otherwise the period of delayed reconciliation has expired. The change in value may be representative of a net increase or a net decrease in value, according to some examples. The change in value or a portion thereof may be allocated to the sending user, the recipient, or a combination therebetween. The change in value or a portion thereof may be allocated to the payment service or an external party (e.g., securities broker), according to some examples. In some examples, the change in value may be presented to the sending user as an incentive or otherwise a motivation to select a particular gift. For example, a sending user may be presented with a notice that upon sending a particular cryptocurrency to a recipient, the sending user would receive any change in value accrued over the period of delayed reconciliation as a reward for selecting such a cryptocurrency. Once the recipient claims or selects the cryptocurrency as the desired asset option, the payment service would facilitate transfer of the ownership of the underlying security to the recipient and allocate at least a portion of the profits to the sending user. Other incentives, rewards, motivations may be provided by the payment service, according to some examples.

Furthermore, the payment service may provide rewards (e.g., discounts, credit, cash back, or other incentives) to users for a variety of reasons. Incentives could be given to a user for: selecting a particular digital asset recommendation, performing a particular request by payment service, or simply providing/sharing his/her location data. The payment service may further provide a recipient with rewards associated with a selected digital asset recommendation. Similar to digital asset recommendations, rewards may be provided to a user based on location data provided by the user, the user's transaction activity, or other data associated with the user. For example, if a user's location data indicates that the user is in a reward location as defined by the payment service, the user may receive a reward from the payment service. The payment service as described herein may also permit a user to transmit rewards to another user or group of users, similar to that of transmitting stored value or a digital asset.

According to some examples, the payment service may fund rewards provided to its users to encourage particular activity or otherwise provide benefits to its users for using the payment service. Rewards may be further based on agreements made between the payment service and merchants or other providers affiliated with products, services, or other digital assets. Merchants or other providers may agree to provide (via the payment service) rewards to the users of the payment service (e.g., users transferring stored value, recipients that receive stored value) or the payment service itself. Accordingly, the payment service may receive a portion of rewards provided to its users.

For example, if a user were to select a particular digital asset (e.g., merchant gift card) as suggested by the payment service to gift or otherwise transmit to a recipient, the user may receive a reward (e.g., discount) in purchasing the particular digital asset. More specifically, if a user selects to purchase a $25.00 merchant gift card for a recipient as suggested by the payment service, the user may only pay $20.00 to purchase the merchant gift card, resulting in a 25% discount on the user's purchase. Similarly, a reward may be provided to the recipient by adding value to the selected particular digital asset when received by the recipient. As another example, if a recipient selects to receive a particular digital asset as suggested by the payment service, the recipient may receive added value in addition to the stored value received by the recipient. More specifically, if a recipient selects to receive a $25.00 merchant gift card as suggested by the payment service, the recipient may receive an additional $5.00 value on top of the $25.00 value received, resulting in a total of $30.00 received. As a further example, if a recipient selects a digital asset recommendation to receive $50.00 USD to a particular merchant, the merchant may issue a $50.00 gift card to the recipient and pay the payment service a reward of $5.00. Similarly, if a recipient selects a digital asset recommendation to receive half a share of equity in a particular stock, the payment service may receive a transaction fee by a broker affiliated with the particular stock.

When purchasing a gift using prior methods, a gift giver may purchase a product, service, or merchant credit (e.g., gift card) with a particular value, limiting the recipient to only that product, service, or merchant. Gift givers are often frustrated with this process if the product, service, or merchant credit remains unused. Furthermore, gift givers may sometimes wonder whether or not the product, service, or merchant credit gifted to a recipient has been used by the recipient at all. The present technology improves on the prior processes for gifting by providing the recipient with the ability to choose how to use a stored value received from the user and—once the stored value is used by the recipient—providing a notice to the gift giver indicating that the gift has been used or otherwise selected by the recipient. In this way, the present technology may confirm for a gift giver that the recipient not only received the stored value, but has made a selection to put the value to use.

In addition to permitting a recipient to choose how to claim, accept, receive and/or use a stored value, the present technology permits the user (e.g., gift giver) to obtain and transmit the stored value using funds provided by multiple methods of payment (e.g., bank accounts, payment cards, cash balances, other units of value tied to the user's account of the payment service, etc.) or even a combination thereof. A user may further obtain a stored value using multiple currencies of her/his choice, while the recipient may receive the stored value in one or more currencies of her/his choice. Currency may include fiat currency, cryptocurrency, equity value, or other monetary value represented by digital assets. Examples of fiat currency may include, but are not limited to, the US Dollar, European Euro, Chinese Yuan, Japanese Yen, British Pound, as well as other government-backed currencies. Examples of cryptocurrency may include, but are not limited to, Bitcoin, Ethereum, Litecoin, Ripple, as well as other cryptography-supported digital assets. Examples of equity value may include, but are not limited to, stockholder equity, common/preferred stock or a group of common/preferred stocks, or fractional shares thereof, among others.

The following description provides specific details for a thorough understanding and an enabling description of these implementations. One skilled in the art will understand, however, that the disclosed system and methods may be practiced without many of these details. Additionally, some well-known structures or functions may not be shown or described in detail, so as to avoid unnecessarily obscuring the relevant description of the various implementations. The terminology used in the description presented below is intended to be interpreted in its broadest reasonable manner, even though it is being used in conjunction with a detailed description of certain specific implementations of the disclosed system and methods. Some frequently used terms are now described.

The phrases “in some examples,” “according to various examples,” “in the examples shown,” “in one example,” “in other examples,” “various examples,” “some examples,” and the like generally mean the particular feature, structure, or characteristic following the phrase is included in at least one example of the present disclosure, and may be included in more than one example of the present disclosure. In addition, such phrases do not necessarily refer to the same examples or to different examples. If the specification states a component or feature “may,” “can,” “could,” or “might” be included or have a characteristic, that particular component or feature is not required to be included or have the characteristic.

The term “module” refers broadly to software stored on non-transitory storage medium (e.g., volatile or non-volatile memory for a computing device), hardware, or firmware (or any combination thereof) modules. Modules are typically functional such that they that may generate useful data or other output using specified input(s). A module may or may not be self-contained. An application program (also called an application) may include one or more modules, or a module may include one or more application programs.

The preceding summary is provided for the purposes of summarizing some examples to provide a basic understanding of aspects of the subject matter described herein. Accordingly, the above-described features are merely examples and should not be construed as limiting in any way. Other features, aspects, and advantages of the subject matter described herein will become apparent from the following description of Figures and Claims.

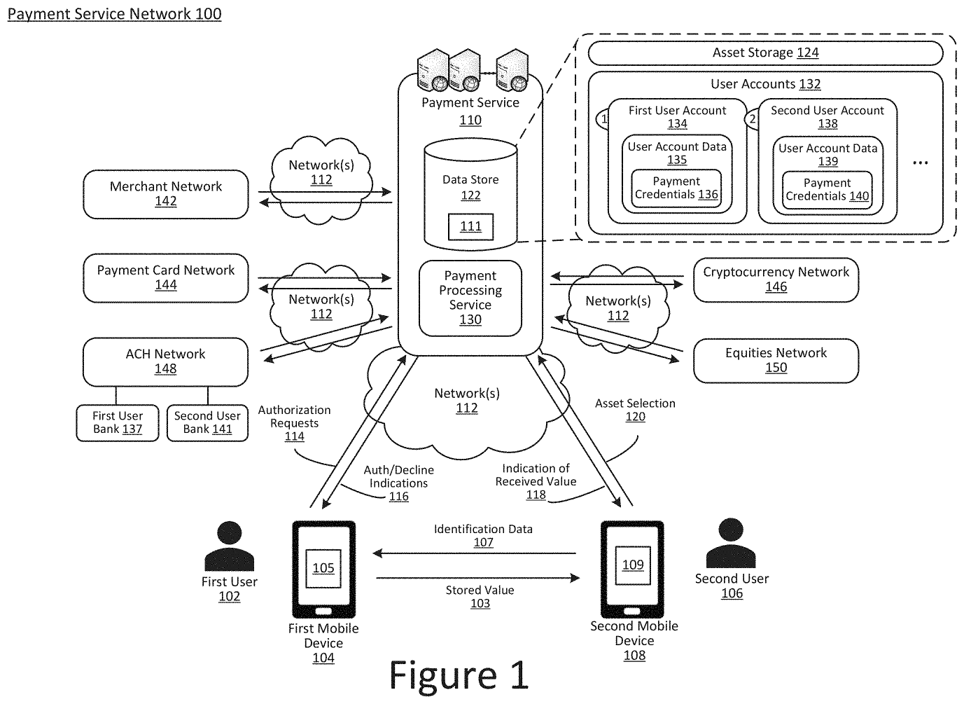

FIG. 1 illustrates a payment service network in accordance with one example embodiment. The payment service network 100 includes first user 102 that wishes to provide a stored value to second user 106, according to some examples. Payment service network 100 also illustrates a payment service 110 (also referred to as a payment service system), which may include payment processing service 130 and user accounts 132. User accounts 132 may include a first user account 134 and a second user account 138, wherein user account data 135 and 139 may be stored therein, respectively. Payment service 110 may be communicatively coupled via network(s) 112 to mobile devices, each of which may be associated with a user of payment service 110. For example, payment service 110 is communicatively coupled to first mobile device 104 associated with first user 102 and second mobile device 108 associated with second user 106 via a network 112.

First mobile device 104 and second mobile device 108 may be any mobile or non-mobile device that include instances of a payment application executing thereon. The payment application 111 may be stored in data store 122 and provided by payment service 110. First mobile device 104 and second mobile device 108 may send payment application requests to payment service 110. In response, payment service 110 may provide instances of the payment application back to first mobile device 104 and/or second mobile device 108. In doing so, payment service 110 may map an identification of the instance of the payment application 111 to the respective user accounts 132.

Each instance of the payment application 111 may include an indication of at least one user account of user accounts 132. For example, the instance of the payment application 105 executing on first mobile device 104 may include an indication of first user account 134 of user accounts 132. Similarly, the instance of the payment application 109 executing on second mobile device 108 may include an indication of second user account 138 of user accounts 132. Payment applications 105 and 109 may enable first mobile device 104 and second mobile device 108, respectively, to transmit payments between first user account 134 (e.g., first user 102) and second user account 138 (e.g., second user 106). Payment applications 105 and 109 executing on first mobile device 104 and second mobile device 108 respectively, may transmit data therebetween or to/from payment service 110.

Using payment application 105, first user 102 may transmit from first mobile device 104 to payment service 110 an authorization request to transmit a stored value of a specified value amount to second user account 138, as illustrated at 114. Authorization request 114 may include an indication of a specified value amount, a payment method to complete a transaction for a stored value of the specified value amount, identification data associated with second user account 138, among other data. Authorization request 114 may include more than one indication of a specified value amount, more than one payment method, and more than one identification data. Payment service 110 may receive authorization request 114 from first mobile device 104 and determine the authorization request 114 to be transmitted by first mobile device 104, wherein payment application 105 executing thereon includes an indication of first user account 134 of user accounts 132.

Upon receiving authorization request 114, payment service 110 may identify the payment method indicated in authorization request 114 as funds stored in first user account 134 and determine whether first user account 134 contains funds (or an aggregate value) greater than or equal to the specified value amount as indicated by authorization request 114. For example, authorization request 114 may indicate a payment method of US dollars stored in first user account 134. Payment service 110 may determine whether first user account 134 contains at least the specified value amount in US dollars in order to obtain a stored value. If first user account 134 does not contain at least the specified value amount of funds, payment service 110 may transmit to payment app 105 of first mobile device 104 an indication that first user account 134 has insufficient funds to complete authorization request 114.

Accordingly, first user 102 may request a loan from payment service 110 with predetermined or custom contract conditions in order to facilitate the transfer of the stored value. Loans with predetermined contract conditions may also be suggested to first user 102 by payment service 110 in the event that a loan may need to be facilitated. The predetermined contract conditions may be set by payment service 110, including a predetermined time frame and a suggested interest rate, based on transaction activity associated with first user 102. For example, payment service 110 may determine that first user 102 can afford to pay weekly or monthly loan installments at a certain interest rate based on the income flow and transaction activity associated with first user 102. First user 102 may approve or deny the suggestion for a loan using payment application 105 executing on first mobile device 104. According to another example, a loan with custom contract conditions may be designed by first user 102 and submitted as a request for approval to payment service 110. The custom contract conditions may be enabled by a drafting procedure provided by payment service 110 and facilitated by payment application 105 executing on first mobile device 104. The option to request a loan may be a feature provided by payment service 110 to be facilitated through a user's mobile device (e.g., first mobile device 104).

Upon receiving an indication that first user account 134 has insufficient funds to complete authorization request 114, first user 102 may also transmit a second authorization request 114 indicating a new payment method. The new payment method may be associated with a payment network or other funds external to payment service 110. Once first user account 134 has sufficient funds, payment service 110 may transmit the specified value amount from first user account 134 to asset storage 124 of payment service 110. According to some examples, transmitting the specified value amount from first user account 134 to asset storage 124 of payments service 110 may include debiting the specified value amount from first user account 134 and crediting or otherwise depositing to asset storage 124 a stored value equivalent to the specified value amount.

Payment service 110 may identify second user account 138 associated with the identification data indicated in authorization request 114. Payment service 110 may further identify second mobile device 108 associated with second user account 138 and transmit to second mobile device 108 an indication of received value 118. According to some examples, indication of received value 118 may include, but is not limited to, an indication (via payment application 109, SMS/MMS, e-mail, etc.) that first user 102 transmitted a stored value of a specified value amount, as well as a request for the second user to select a digital asset, among other data. Digital assets may include, but are not limited to merchant credits, merchant discounts, product discounts, services discounts, equities (or portions thereof), cryptocurrencies, fiat currencies, as well as combinations thereof, among others.

According to some examples, a graphical user interface (GUI) may be displayed to second user 106 on second mobile device 108 indicating that the stored value from first user 102 has been received. The GUI may be generated by payment application 109 or otherwise facilitated by the operating system of second mobile device 108 (e.g., SMS/MMS, e-mail, etc.). The GUI may display on second mobile device 108 a request for second user 106 to select one or more digital assets. Second user 106 may provide a selection of one or more digital assets to second mobile device 108. In turn, second mobile device 108 may transmit to payment service 110 an asset selection 120 representative of the selection of one or more digital assets provided by second user 106. According to some examples, asset selection 120 may indicate a digital asset amount equivalent to the stored value transmitted by first user 102. According to other examples, asset selection 120 may indicate a digital asset amount provided by second user 106 using the GUI of second mobile device 108.

For example, the second user 106 (e.g., the recipient) can select more than one gift that is within the limit of the stored value that was originally sent by the first user 102. For instance, for a $100 stored value sent, the recipient could select $25 in securities for the merchant, $50 merchant specific credit, and $25 in cash.

Upon receiving asset selection 120, payment service 110 may identify the storage location of asset storage 124 associated with asset selection 120 and fetch therefrom the digital asset amount according to the amount provided by asset selection 120. Payment service 110 may debit asset selection 120 from asset storage 124 and credit or otherwise deposit asset selection 120 to second user account 138. According to some examples, asset selection 120 may indicate a digital asset amount equivalent to the stored value transmitted by first user 102. Asset selection 120 may otherwise indicate a digital asset amount that is a portion of the stored value transmitted by first user 102 as provided by second user 106. If the digital asset amount is not equivalent to the stored value transmitted by first user 102, payment service 110 may further transmit from asset storage 124 to second user account 138 any unused stored value transmitted by first user 102, according to some examples.

Payment service 110 may transmit indications that the stored value has been accepted by second user 106. For example, payment service 110 may transmit at 114 an indication to first mobile device 104 that the stored value has been accepted by second user 106 and received at second user account 138. This indication may include at least some of the information provided by asset selection 120 (e.g., selection of one or more digital assets, a digital asset amount) provided by second mobile device 108. As another example, payment service 110 may transmit an indication of received value 118 to second mobile device 108 that the stored value has been successfully received at second user account 138 as the selection of one or more digital assets indicated by asset selection 120. Second mobile device 108 may display the indication of received value 118 upon second mobile device's transmittal of asset selection 120 to provide immediate assurance that the stored value has been successfully received at second user account 138 as the selection of one or more digital assets indicated by asset selection 120. Payment service may alternatively transmit at 114 an indication to first mobile device 104 that the stored value has been rejected by second user 106 and returned to first user account 134.

Upon receiving authorization request 114, payment service 110 may determine that the payment method indicated in authorization request 114 is associated with a payment network and, as such, may fetch the payment method credentials 136 associated thereto from user account data 135 of first user account 134. For example, authorization request 114 may indicate a payment card (e.g., a credit card, debit card) of first user account 134 that is associated with payment card network 144 or an external bank account (e.g., checking account, savings account) that is associated with ACH network 148, among others. Payment service 110 may transmit the payment method credentials 136 to payment processing service 130 for processing to fulfill authorization request 114.

Payment processing service 130 may attempt to fulfill authorization request 114 by processing the payment method credentials 136 of first user account 134. Payment processing service 130 may be communicatively coupled through network(s) 112 to one or more payment networks associated with payment methods of user accounts 132. According to some examples, the one or more payment networks may include, but are not limited to, merchant network 142, payment card network 144, cryptocurrency network 146, ACH network 148, and equities network 150. Payment method credentials 136 and 140 provided by first user account 134 and second user account 138 may be associated with a particular payment network.

Payment processing service 130 may communicate with one or more computing devices of the payment network associated with the payment method credentials 136 fetched from user account data 135 of first user account 134. For example, payment method credentials 136 may be indicative of a payment card associated with payment card network 144 (e.g., MasterCard®, VISA®). Payment processing service 130 may communicate over network(s) 112 with payment card network 144 in an attempt to initiate a financial transaction using the payment method credentials 136 for the specified value amount (or a portion from each) as indicated in authorization request 114.

Payment processing service 130 can further communicate with computing devices of one or more banks, processing/acquiring services, or the like (e.g., merchant network 142, ACH network 148, cryptocurrency network 148, and equities network 150). For example, payment processing service 130 may communicate with ACH network 148 in order to communicate with banks associated with payment method credentials 136 (e.g., an acquiring bank, an issuing bank, and/or a bank maintaining user accounts for electronic payments). ACH network 148 may include a first user bank 137 associated with first user account 134 and may further include a second user bank 141 associated with second user account 138.

An acquiring bank may be a registered member of a card association (e.g., Visa®, MasterCard®), and may be part of a payment card network 144. An issuing bank of ACH network 148 may issue credit cards to users and may pay acquiring banks for purchases made by cardholders to which the issuing bank has issued a payment card. Accordingly, in some examples, the computing device(s) of a bank (e.g., first user bank 137, second user bank 141) may be included in payment card network 144 and may communicate with the computing devices of a card-issuing bank of ACH network 148 to obtain payment. Further, in some examples, authorization request 114 may indicate a debit card as the payment method instead of a credit card, in which case, the bank computing device(s) of a bank corresponding to the debit card may receive communications regarding a transaction in which the customer is participating. Additionally, there may be computing devices of other financial institutions involved in some types of transactions or in alternative system architectures, and thus, the foregoing are merely several examples for discussion purposes.

In addition to receiving payment method credentials (e.g., payment method credentials 136, payment method credentials 140) from user account data (e.g., user account data 135, user account data 139) of user accounts 132, payment processing service 130 may also access asset storage 124 stored in data store 122 and maintained by payment service 110. Payment processing service 130 may transfer funds according to the specified value amount from a payment network to user accounts 132. For example, payment processing service 130 may receive from payment card network 144 an indication that the payment method credentials 136 are valid and that a successful financial transaction has been completed using the payment method credentials 136. Payment processing service 130 may transmit to first mobile device 104 an indication 116 that the payment method(s) is valid and the financial transaction successful. Payment processing service 130 may receive from payment card network 144 an indication that the financial transaction failed using the payment method credentials 136. Upon receiving indication of a failed financial transaction, payment processing service 130 may transmit to first mobile device 104 an indication 116 that the payment method(s) has been declined.

Payment processing service 130 may receive funds according to the successful financial transaction of a payment network over network(s) 112. Payment processing service 130 may transmit from payment card network 144 to asset storage 124 the funds received from the successful financial transaction. According to some examples, the funds received may be equal to or near equal to the specified value amount as indicated in the authorization requests. Payment processing service 130 may deposit to asset storage 124 the funds received from a payment network. According to other examples, payment processing service 130 may alternatively deposit directly to first user account 134 or second user account 138 the funds received from a payment network according to authorization request 114. Payment processing service may deposit funds in the form of a stored value as requested by authorization request 114. Payment service 110 may transmit to first mobile device 104 an indication 116 that the stored value has been deposited.

While FIG. 1 illustrates direct communication between payment processing service 130 and payment networks (e.g., requesting to authorize the payment method), in some instances, the payment networks may provide an indication of valid payment credentials and/or a successful financial transaction without immediately transferring funds. According to some examples, funds may be provided at a delay by payment networks to payment processing service 130 as part of a batched, periodic process (e.g., during ACH network transfers). Funds not yet received by payment processing service 130 may be loaned by payment service 110 until received by a completed batched, periodic process. Alternatively, payment processing service 130 may consider any funds delayed by a batched, periodic process as received, permitting only internal transmission of such funds until the batched, periodic process has completed.

The authorization request 114 may be transmitted from first mobile device 104 using a plurality of authorization requests. In doing so, authorization request 114 may transmit the information contained therein (e.g., an indication of a specified value amount, a payment method to complete a transaction for a stored value of the specified value amount, identification data, among other data) as individual authorization requests sent at different times. For example, first mobile device 104 may transmit an indication of a specified value amount and an indication of a payment method to complete the transaction for a stored value of the specified value amount in a first authorization request while transmitting identification data associated with second user account 138 in a second authorization request. In other words, authorization request 114 may include one or more authorization requests, according to some examples.

First mobile device 104 and second mobile device 108 may directly communicate with each other in a peer-to-peer fashion using wireless communication capabilities, such as that provided by near-field communication (NFC) and Bluetooth technologies, among others. According to some examples, wireless communication capabilities may further include cellular technology network (e.g., SMS/MMS messages, voice, and data services). For example, using payment application 105, first user 102 may directly transmit (in a peer-to-peer fashion) from first mobile device 104 to second mobile device 108 a representation of a stored value 103 (e.g., to initiate a transfer of a stored value similar to authorization request 114) using wireless communication capabilities. Accordingly, payment application 109 may transmit from second mobile device 108 to payment service 110 an authorization request 114 on behalf or instead of first mobile device 104. Alternatively, payment application 109 may directly transmit (in a peer-to-peer fashion) from second mobile device 108 back to first mobile device 104 identification data 107 to be included in authorization request 114 as described above. Directly transmitting data (e.g., stored value 103, identification data 107) in a peer-to-peer fashion may initiate a payment application (e.g., payment application 105, payment application 109) to transmit an authorization request (e.g., authorization request 114) from the associated mobile device (e.g., first mobile device 104, second mobile device 108) to payment service 110.

As another example, second mobile device 108 may transmit to first user device 104 identification data 109 associated with second user account 138 (e.g., for use in authorization request 114) using wireless communication capabilities. As yet another example, first mobile device 104 may determine that second mobile device 108 is present using wireless communication capabilities and initiate a transfer of data (e.g., a representation of a stored value 103).

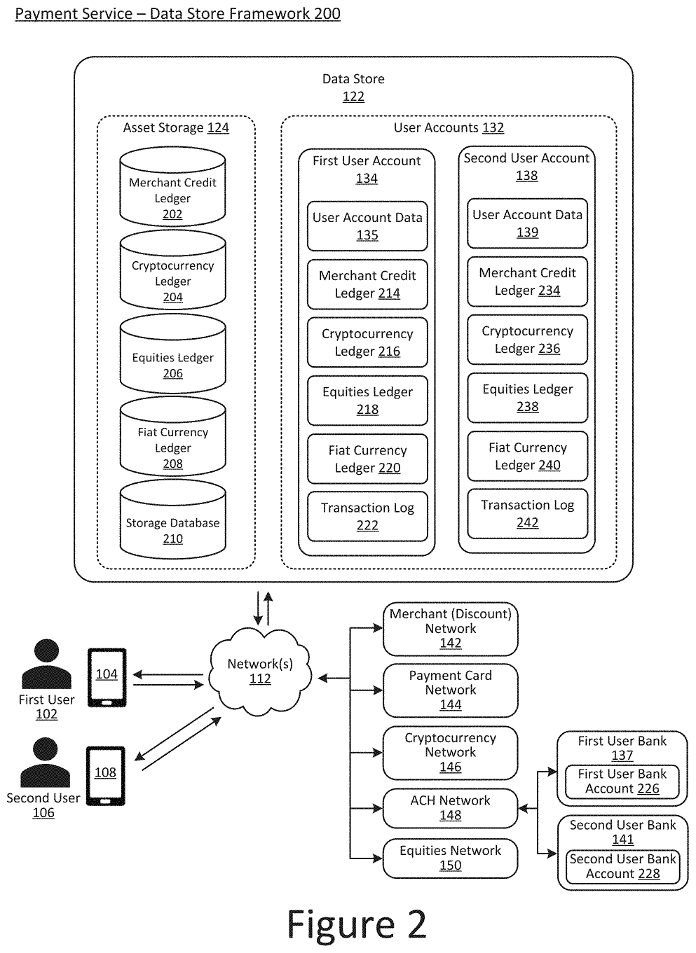

FIG. 2 illustrates a data store framework of a payment service network in accordance with one example embodiment. As described above, data store 122 of payment service 110 may include asset storage 124 and user accounts 132. Asset storage 124 may include individual ledgers for each digital asset (e.g., merchant credits, merchant discounts, product discounts, services discounts, equities, portions of equities, cryptocurrencies, fiat currencies, combinations thereof, among others) supported by payment service 110. As shown in FIG. 2, asset storage 124 includes asset ledgers 202, 204, 206, and 208, as well as a storage database 210 to store the actual digital assets. Specifically, asset storage 124 may include merchant credit ledger 202 used to store or otherwise record debits and credits of merchant credit associated with payment service 110. Examples of merchant credit may include, but are not limited to, merchant gift cards, merchant discounts, or other value exchangeable during transactions with one or more merchants. Asset storage 124 may further include cryptocurrency ledger 204 used to store or otherwise record debits and credits of cryptocurrency associated with payment service 110. Examples of cryptocurrency may include, but are not limited to, Bitcoin, Ethereum, Litecoin, Ripple, as well as other cryptography-supported digital assets. Furthermore, asset storage 124 may include equities ledger 206 used to store or otherwise record debits and credits of equity value associated with payment service 110. Examples of equity value may include, but are not limited to, common/preferred stock or a group of common/preferred stocks, shareholder equity, shareholder dividends, foreign exchange products, earnings from financial assets, other exchangeable or non-exchangeable assets of financial values, as well as fractional portions thereof. Fiat currency ledger 208 of asset storage 124 may be used to store or otherwise record debits and credits of fiat currency associated with payment service 110. Examples of fiat currency may include, but are not limited to, the US Dollar, European Euro, Chinese Yuan, Japanese Yen, British Pound, as well as other government-backed currencies.

Asset ledgers of asset storage 124 may be used to track the credits and debits of each digital asset associated with payment service 110. Accordingly, storage database 210 may be used to store data indicative of the actual digital assets tracked, organized, and otherwise represented by the asset ledgers of asset storage 124. Specifically, storage database 210 may include storage locations associated with each asset ledger of asset storage 124. For example, storage database 210 may include a cryptocurrency wallet used to store the actual cryptocurrency recorded by cryptocurrency ledger 204.

As described above, user accounts 132 of payment service 110 may include a first user account 134 and second user account 138. Each of user accounts 132 may store user account data associated with each user, as well as information related to the respective balances of digital assets and transaction activity associated with each user account. For example, first user account 134 includes user account data 135 as described in FIG. 1 used to store data associated with first user account 134. Similarly, second user account 138 includes user account data 139 used to store data associated with second user account 138. User account data 135 and 139 may include access to external bank accounts. For example, user account data 135 may include payment credentials 136 that grant access to one or more accounts (e.g., first user bank account 226) associated with first user account 134 at first user bank account 137. As a further example, user account data 139 may include payment credentials 140 that grant access to one or more accounts (e.g., second user bank account 228) associated with second user account 138 at second user bank 141. Payment credentials 136 and 140 may further include access to other payment networks, such as external payment card networks (e.g., payment card network 144) to facilitate transactions with credit cards, debit cards, and the like. According to some examples, user account data 135 and 139 may further include preference profiles or user account models indicative of user preferences maintained by payment service 110.

Similar to asset storage 124, each user account of user accounts 132 may include individual ledgers for each digital asset (e.g., merchant credits, merchant discounts, product discounts, services discounts, equities, portions of equities, cryptocurrencies, fiat currencies, combinations thereof, among others) for the associated user account. User account structure 200 illustrates that first user account 134 may include merchant credit ledger 214, cryptocurrency ledger 216, equities ledger 218, and fiat currency ledger 220, as well as a transaction log 222. Similarly, second user account 138 may include merchant credit ledger 234, cryptocurrency ledger 236, equities ledger 238, fiat currency ledger 240, as well as a transaction log 242. Merchant credit ledgers 214 and 234 may each be used to store or otherwise record debits and credits of merchant credit associated with first user account 134 and second user account 138, respectively.

Cryptocurrency ledgers 204 and 236 may be used to store or otherwise record debits and credits of cryptocurrency associated with first user account 134 and second user account 138, respectively. Equities ledgers 206 and 236 may be used to store or otherwise record credit and debits of equity value associated with first user account 134 and second user account 138, respectively. Fiat currency ledgers 208 and 238 may be used to store or otherwise record debits and credits of fiat currency associated with first user account 134 and second user account 138, respectively.

Transaction logs 222 and 242 may be used to store or otherwise record transaction data indicative of each transaction associated with first user account 134 and second user account 138, respectively. Transaction data recorded by transaction logs 222 and 242 may include, but are not limited to, type of digital asset used to facilitate transaction, value of digital asset, date of transaction, among others. Storage database 210 may be used to store the actual digital assets tracked, organized, and otherwise represented by the asset ledgers of each of user accounts 132. Each user account data 135 and 139 of user accounts 132 may also include access to external accounts that facilitate such digital assets, such as third party cryptocurrency exchanges/wallets (e.g., cryptocurrency network 146), equity holding accounts (e.g., equities network 150), among others.

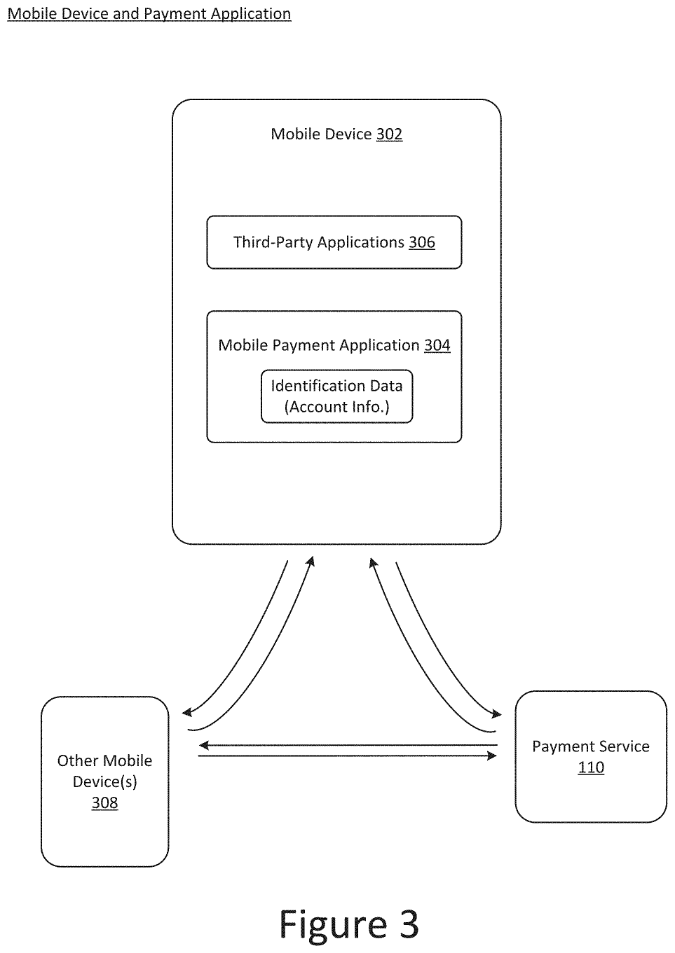

FIG. 3 illustrates a mobile device and payment application in accordance with one example embodiment. A payment application 304 may run on a user's mobile device 302 (e.g., first mobile device 104) which uses wireless communication capabilities and protocols (e.g., near-field communication (NFC), Bluetooth, SMS/MMS messages, voice, data services, and the like) to communicate with other mobile device(s) 308 (e.g., second mobile device 108) and payment service 110. Mobile device 302 can also include other e-commerce applications, such as third-party applications 306 that can be used by a user to store value (e.g., cryptocurrency wallets), purchase products or services (e.g., e-commerce applications) or otherwise communicate with payment application 304 (e.g., a third-party requesting application), among others. Third-party applications 306 may be associated with one or more merchant systems, according to some examples. The third-party applications 306 can also be websites, forums, URLs, application program interfaces (APIs), or any source website or application that either hosts a description of a product or service and/or provides an option to buy the product or service. The payment application 304 can also be a website provided by a payment service (e.g., payment service 110), or any source website or application that provides a portal to send and accept payments using payment service 110. Third-party application 306 and payment application 304 can be accessed through a web browser (e.g., Chrome® or Safari®) on the mobile device 302, according to some examples. In other examples, third-party applications 306 and the payment application 304 can be software applications downloadable via an application store (e.g., Google Play Store®, Apple App Store®, etc.). Once accessed or registered into the applications 304 and 306, user account credentials or other account identification data may be stored on mobile device 302 for subsequent customer visits (for example, through web browser authentication, web cookies, web history, etc.), allowing the customer to access the application without logging-in to an account. The description herein is with reference to payment application 304 as an installed application; however, it will be understood that payment application 304 as an authenticated or unauthenticated application on a web browser is within the meaning of the term.

The payment application 304 can include an electronic wallet application, money transfer application (e.g., application for sending and receiving money via email or phone), or any other application having an account identifier that is linked to one or more payment cards and/or bank accounts and can be used by the owner of the mobile device to initiate transactions. Such transactions can include person-to-person transactions, traditional purchase transactions between customers and merchants, among others.

Payment application 304 may also be used to manage internal payment cards (e.g., payment cards issued by payment service 110 to user accounts 132). Options with respect to internal payment cards can be adjusted and managed using application 304. For example, when user accounts 132 includes multiple payment methods (e.g., credit card and bank account), application 304 can set one of those payment methods to be the default method for debits or credits when using an internal payment card.

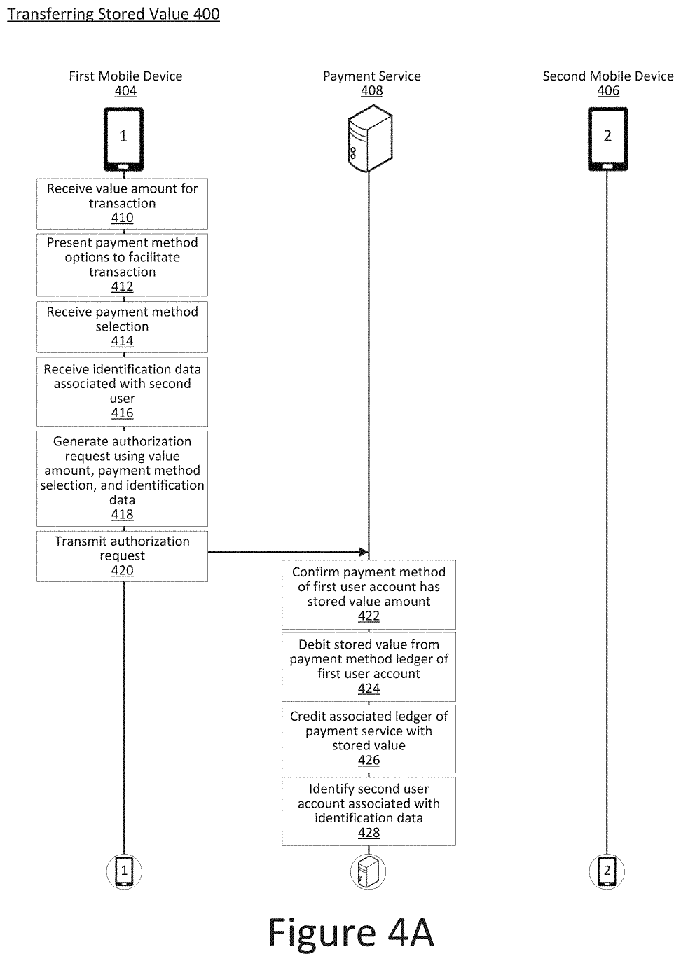

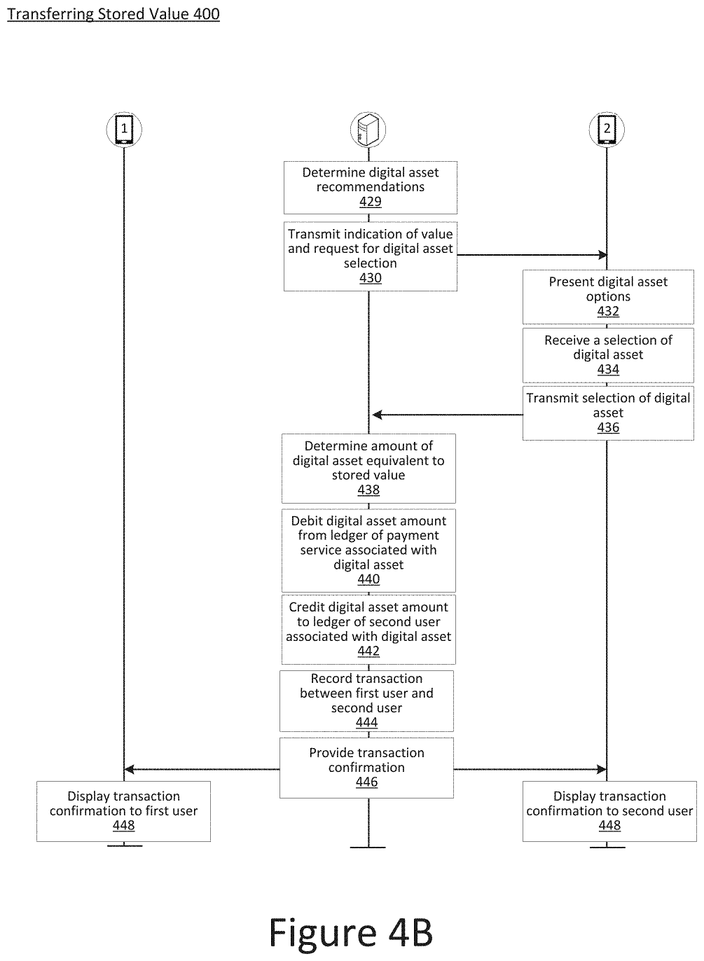

FIG. 4A illustrates a method for peer-to-peer transfer in accordance with one example embodiment. First mobile device 404 (e.g., first mobile device 104) may receive a specified value amount (410) from the first user (e.g., first user 102) of first mobile device 404 using a payment application (e.g., payment application 105, payment application 304) executing on first mobile device 404. First mobile device 404 may present payment method options to the user (412) using the payment application. Payment method options may include payment methods associated with the user's account (e.g., first user account 134), including, but not limited to, funds stored in the user's account, or a payment method associated with a payment network.

First mobile device 404 may receive a selection of a payment method (414) from the user and may further receive identification data associated with a second user account (e.g., second user account 138) (416) using the payment application. First mobile device 404 may generate an authorization request (e.g., authorization request 114) (418) containing information provided by the first user, such as the specified value amount, the selected payment method, and the provided identification data. The authorization request may then be transmitted by first mobile device 404 (420) to payment service 408 (e.g., payment service 110).

Payment service 408 may receive the authorization request from first mobile device 404 and identify the ledger (e.g., fiat currency ledger 220) of the first user account associated with the payment method as provided in the authorization request. Upon doing so, payment service 408 may confirm that the associated ledger of first user account indicates at least a stored value equivalent to the value amount provided in the authorization request (422). Payment service 408 may debit the value amount from the associated ledger of the first user (424) and credit the associated ledger (e.g., fiat currency ledger 208) of the payment service (426). Payment service 408 may then use the identification data provided in the authorization request to identify the second user account (e.g., second user account 138) and second mobile device 406 (e.g., second mobile device 108) associated thereto (428).

FIG. 4B illustrates a method for peer-to-peer in accordance with one example embodiment. The method as illustrated in FIG. 4B can be a continuation of the method of FIG. 4A. Payment service 408 may determine digital asset recommendations (429) catered to the preferences of the second user (e.g., second user 106). The digital asset recommendations may be generated from the transaction activity (e.g., stored in transaction log 242), location data (e.g., stored in user account data 139), and other data stored in the user account data (e.g., user account data 139) of the second user account as identified at 428.

According to some examples, the digital asset recommendations for the second user may be generated based on the second user's preference profile. A preference profile associated with the second user may be generated and maintained by payment service 408 based on data (e.g., transaction activity, location data, and other data) stored in the second user account as identified at 428. The preference profile may include a trained model and other data indicative of preferences or other patterns associated with the second user. Accordingly, the preference profile may be trained using prediction algorithms or other machine learning models that reflect which digital asset the second user may most prefer. The preference profile may be stored in the user account data of the second user account and may be routinely updated by payment service 408 based on new data associated with the second user account. As such, payment service 408 may use the preference profile of the second user to determine which digital assets are most correlated to the second user. Accordingly, the digital asset recommendations may be determined according to a preference profile as stored in the user account data of the second user account and further included in an indication for transmission to second mobile device 406. Digital asset recommendations may include merchant credits, merchant discounts, product discounts, services discounts, equities (or portions thereof), cryptocurrencies, fiat currencies, as well as combinations thereof, among others.

According to some examples, payment service 408 may determine digital asset recommendations based on a probability map. The probability map for the second user may indicate which of the digital assets facilitated by the payment service 408 are most correlated or otherwise similar to the second user's preference profile, as well as other data or behaviors associated thereto. The probability map may be generated using the preference profile and other data (e.g., transaction activity, location data, etc.) stored in the second user account. According to some examples, the probability map may be generated dynamically for each set of digital asset recommendations provided to a second user. The probability map may also be generated using previously determined probability maps associated with the second user. Accordingly, the probability map may be stored in the data store of payment service 408 for later use in determining other probability maps or digital asset recommendations at a future time.

According to some examples, digital asset recommendations may further include one or more rewards (e.g., discounts, credit, cash back, or other incentives) associated thereto. Rewards may be provided to the first user (e.g., first user 102) associated with first mobile device 404, the first user's account (e.g., first user account 134), the second user (e.g., second user 106) associated with second mobile device 406, the second user's account (e.g., second user account 138), the payment service 408 itself (e.g., payment service 110), or a combination thereof. For example, a digital asset recommendation may include a reward indicative of an additional $5.00 value in exchange for a user selecting the digital asset recommendation. The reward (e.g., $5.00) may be transmitted to one or more accounts associated with users of payment service 408, one or more accounts associated with payment service 408 itself, or a combination thereof.

Payment service 408 may transmit to second mobile device 406 the indication (430) that the first user has transmitted a stored value of a specified value amount. The indication may include the digital asset recommendations determined at 429, as well as a request for the second user to make a selection of a digital asset in which to receive the stored value. Second mobile device 406 may present the digital asset recommendations as options suggested to the second user (432) using a payment application (e.g., payment application 109, payment application 403) executing on second mobile device 406.

Second mobile device 406 may receive a selection of one or more digital assets (434) from the user using the payment application. Second mobile device 406 may then transmit the digital asset selection (e.g., asset selection 120) (436) to payment service 408. The digital asset selection may further include an indication of a digital asset amount provided by the second user using the payment application. The digital asset amount included in the digital asset selection may be less than or equal to the value amount provided in the authorization request from first mobile device 404. According to some examples, payment service 408 may determine a digital asset amount (438) if one is not provided in the digital asset selection from second mobile device 406. The digital asset amount determined by payment service 408 may be equal to the value amount provided in the authorization request from first mobile device 404.

Payment service 408 may identify the ledger (e.g., cryptocurrency ledger 204) of the payment service associated with the digital asset selection and further identify the ledger (e.g., cryptocurrency ledger 236) of the second user account associated with the digital asset selection. Upon confirming that the associated ledger of payment service 408 indicates at least a stored value equivalent to the digital asset amount, payment service 408 may then debit the digital asset amount from the associated ledger (e.g., cryptocurrency ledger 204) (440) of payment service 408. In turn, payment service 408 may credit the identified ledger of the second user account (442).

While the associated ledger of payment service 408 reflects two different transactions—one with the first user and one the second user—a single transaction may be apparent to the first user and second user. According to some examples, this single transaction as seen by the first and second user may include at least two sets of data: an indication of the value amount and payment method provided by the first user; and an indication of the digital asset selection and digital asset amount as received by the second user. Accordingly, payment service 408 records the apparent single transaction (444) between the first user and the second user in their associated transaction logs (e.g., transaction log 222 and transaction log 242). The transaction as recorded in the users' transaction logs may further include data associated with the transaction, including, but not limited to, information as included in the authorization request (e.g., authorization request 114) as provided by the first mobile device 404, information as included in the digital asset selection (e.g., asset selection 120) as provided by the second mobile device, and other data associated with the transaction (e.g., data and time of payment by first user, date and time of receipt by second user, location of the first user and second user during the transaction), among other data.

Payment service 408 may provide a transaction confirmation (446) to first mobile device 404 and second mobile device 406. Upon receiving the transaction confirmation from payment service 408, first mobile device 404 and second mobile device 406 may display the transaction confirmation (448) to the first user and second user, respectively.

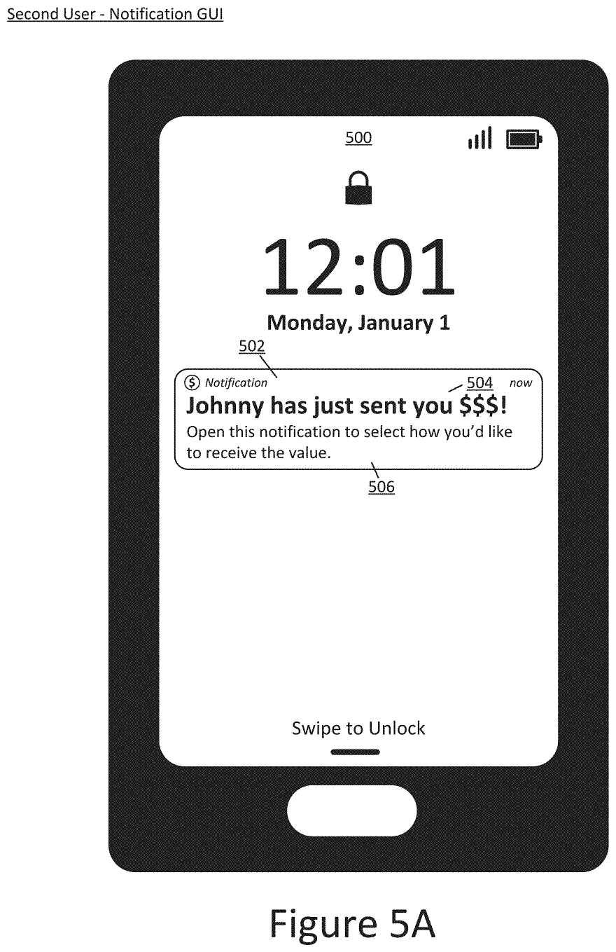

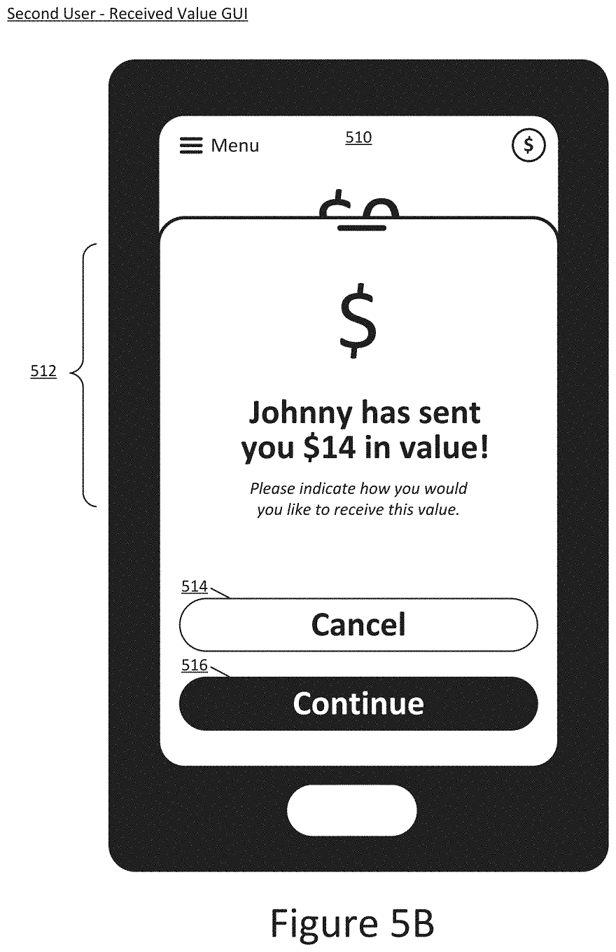

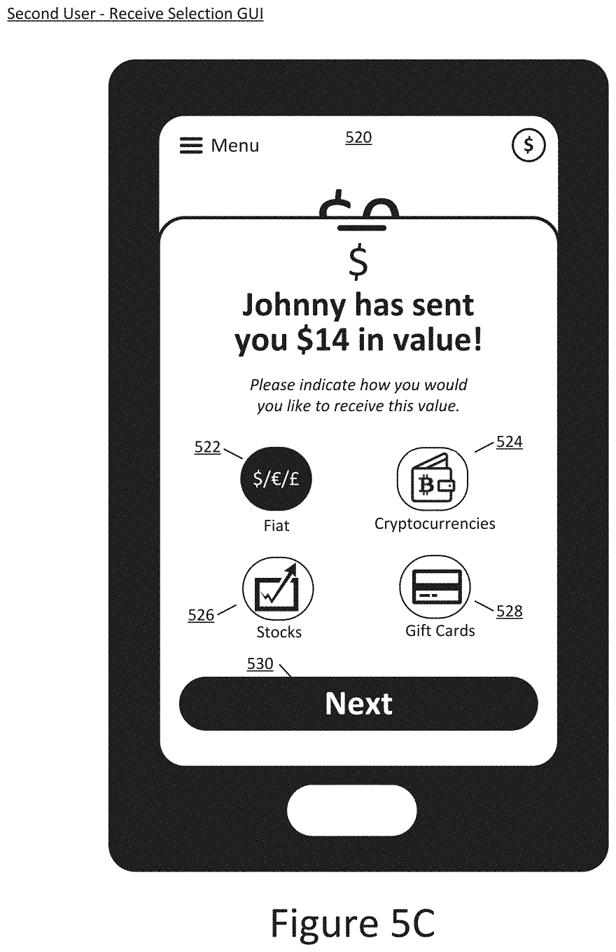

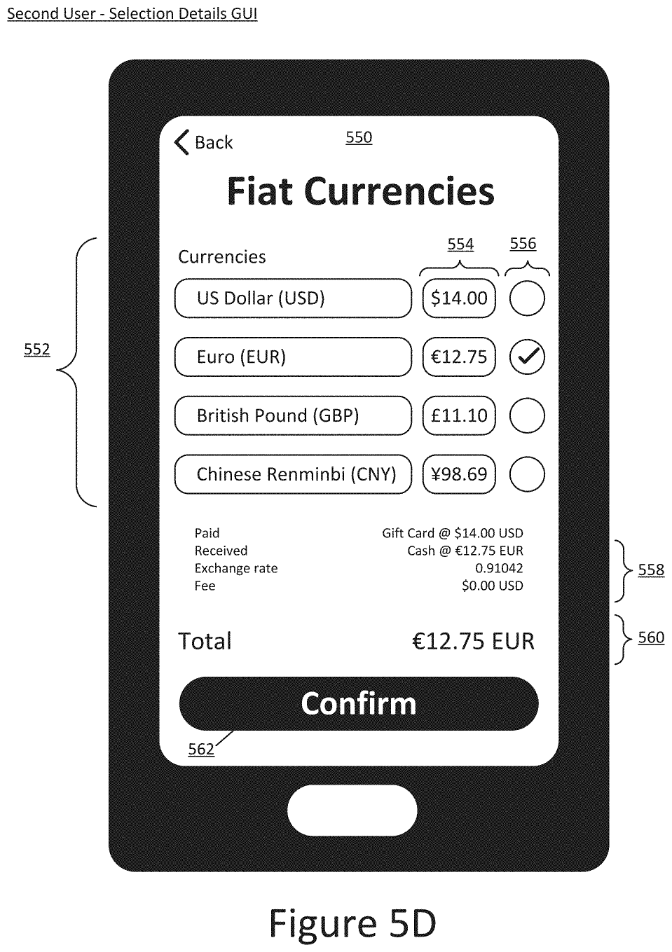

FIG. 5A illustrates a graphical user interface for notifying a user of a received value in accordance with one example embodiment. Graphical user interface (GUI) 500 may display a notification that appears on a second mobile device (e.g., second mobile device 108) of a second user (e.g., second user 106) receiving a stored value. According to some examples, notification 502 may be displayed on the second mobile device after receiving an indication (e.g., indication of received value 118) from a payment service (e.g., payment service 110) that a first user (e.g., first user 102) has sent a stored value. Notification 502 may indicate or otherwise display information as provided by the indication received from the payment service. For example, notification 502 displays in indication 504 that a first user has sent a value, reading “Johnny has just sent you $$$!” as shown in FIG. 5A. Notification 502 may further display an indication 506 providing instructions to the second user. For example, notification 502 displays an indication 506 that requests the second user to provide a selection of a digital asset, reading “Open this notification to select how you′d like to receive the value” as shown in FIG. 5A. Interacting with notification 502 may provide shortcut controls through the operating system executing on the second mobile device. Alternatively, interacting with notification 502 may open the payment application (e.g., payment application 109, payment application 304) associated with notification 502. Furthermore, interacting with notification 502 may display to the second user another GUI (e.g., GUI 510 of FIG. 5B) of the payment application.

FIG. 5B illustrates a graphical user interface for displaying a received value to a user in accordance with one example embodiment. GUI 510 may be displayed on the second mobile device of the second user receiving a stored value from a first user. GUI 510 may be displayed after receiving an indication (e.g., indication of received value 118) from the payment service that the first user has sent a stored value. GUI 510 may also be displayed after receiving an indication of a stored value (e.g., stored value 103) from the first mobile device directly.

GUI 510 may include indications of the information as provided in the indication of received value, such as information 512. Information 512 may indicate a representation of the received value and/or details associated with the first user (e.g., user account image, user account name). For example, information 512 provides that a first user has sent a stored value and inquires how the second user would like to receive it, reading “Johnny has sent you $14 in value! How would you like to receive this value?” as shown in FIG. 5B. According to some examples, GUI 510 may include a cancel button 514 that, when selected, may transmit to the payment service an indication to return the stored value to the first user. GUI 510 may further include a continue button that, when selected, may display to the second user another GUI (e.g., GUI 520 of FIG. 5C) of the payment application.

FIG. 5C illustrates a graphical user interface for receiving an asset selection from a user in accordance with one example embodiment. GUI 520 may be displayed on a second mobile device of a second user instead of GUI 510, after GUI 510, after receiving an indication (e.g., indication of received value 118) from the payment service that the first user has sent a stored value, and/or after receiving an indication of a stored value (e.g., stored value 103) from the first mobile device directly. GUI 520 may also be displayed (e.g., present digital asset options 432) on the second mobile device in order to receive an asset selection (e.g., receive a selection of one or more digital assets 434) from the second user.

GUI 520 may include indications of digital asset options in which the second user may receive the stored value. The digital asset options may include merchant credits, merchant discounts, product discounts, services discounts, equities (or portions thereof), cryptocurrencies, fiat currencies, as well as combinations thereof, among others. For example, GUI 520 provides four GUI elements indicative of digital asset options selectable by the second user, including fiat 522, cryptocurrencies 524, stocks 526, and gift cards 528 as shown in FIG. 5C. Upon being selected, GUI elements 522, 524, 526, and 528 may change or otherwise animate to indicate that the second user has selected the associated digital asset option(s). For example, fiat 522 has been filled in, indicating that the second user has selected to receive fiat currency as the digital asset. GUI 520 may further include a next button 530 that, when selected, may display to the second user another GUI (e.g., GUI 550 of FIG. 5D) according to the selected element of GUI 520.

FIG. 5D illustrates a graphical user interface for receiving details associated with an asset selection in accordance with one example embodiment. GUI 550 may be displayed on a second mobile device and further populated according to the selected element of GUI 520. For example, in response to fiat 522 being selected on GUI 520, GUI 550 may generate an options list 552 containing fiat currencies. GUI 550 may further include GUI elements such as value elements 554 and selection elements 556. Value elements 554 may provide for the second user the amount (e.g., digital asset amount provided by asset selection 120). According to some examples, value elements 554 may be editable or uneditable (e.g., static) by the second user. Selection elements 556 may provide for the second user to indicate which of the options list 552 they would like to receive. GUI 550 may further include information related to the second user's selection, such as receivable summary 558 and receivable total 560. For example, value elements 554 and selection elements 556 indicate that the second user selected Euros from options list 552, updating receivable summary 558 to indicate an exchange rate of 0.91042 and receivable total 560 to indicate a total of €12.75 EUR. GUI 550 may further include a confirm button 562 that, when selected, may initiate second mobile device to generate and further transmit (e.g., transmit selection of digital asset 436) an asset selection (e.g., asset selection 120) to a payment service (e.g., payment service 110, payment service 408), including at least a digital asset selection as indicated by the second user. According to some examples, other information may be transmitted to the payment service, another device, or a plurality of other devices when confirm button 562 is selected; other information including, but not limited to: one or more digital asset selections as provided by the second user, an amount (e.g., receivable total 560) associated with the one or more digital asset selections as provided by the second user, other information (e.g., data provided by receivable summary 558) associated with the one or more digital asset selections as provided by the second user, identification data associated with the second user account, or any other information related to the second user receiving a stored value.

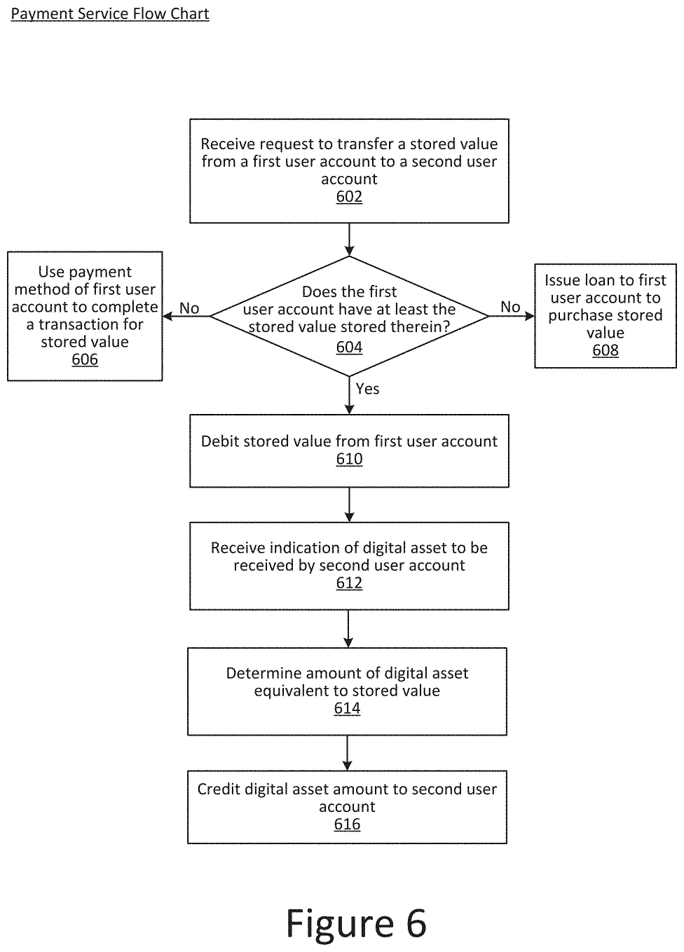

FIG. 6 illustrates a flow chart of a payment service process 600 for transferring a stored value in accordance with one example embodiment. In step 602, the payment service may receive a request to transfer a stored value from a first user account to a second user account. The request to transfer may be received from an application executing on a first mobile device of a first user (e.g., first mobile device 104, first mobile device 404). Alternatively, the request to transfer may be received from another device, application, or service, such as a second mobile device of the second user. According to some examples, a payment method may be indicated in the request to transfer. In step 604, the payment service may determine whether or not the first user account has stored therein at least the stored value intended for transfer. If the first user account does not have at least the stored value stored therein, the payment service may use a payment method of the first user account, such as the payment method indicated in the request to transfer, to complete a transaction for the stored value in step 606. Alternatively, if the first user account does not have at least the stored value stored therein, the payment service may issue a loan to the first user account to purchase the stored value in step 608.

In step 610, the payment service may debit the stored value from the first user account. In doing so, the stored value may be credited to an account associated with the payment service. The payment service may transmit to the second user a request to select a digital asset in which the stored value should be received. According to some examples, the request to select may include digital asset recommendations generated by the payment service based on data associated with the second user account, such as the transaction activity stored therein (e.g., transaction log 242), a preference profile associated with the second user account stored therein (e.g., user account data 139), or a combination thereof, among other data. In step 612, the payment service may receive an indication of a digital asset selection to be received by the second user account. Alternatively, the second user may have previously provided an indication of one or more digital asset selections for the second user account to receive a stored value.

Upon identifying the digital asset indicated by the second user, the payment service may determine, in step 614, the amount of digital asset that is equivalent to the stored value as indicated in the request to transfer. Once a digital asset amount is determined, the digital asset amount may be debited from an account associated with the payment service. In step 616, the payment service may then credit the digital asset amount to the second user account. According to some examples, the payment service may record this transfer of values in its associated data storage (e.g., asset storage 124) as well as the transaction logs of the first user account and second user account (e.g., transaction log 222, transaction log 242). Furthermore, the payment service may also provide confirmation of the transaction to the first user and second user in the form of an SMS/MMS message, email, or other notification receivable by their associated mobile devices (e.g., first mobile device 104/404, second mobile device 108/406).

For clarity of explanation, in some instances the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some examples, a service can be software that resides in memory of a client device and/or one or more servers of a content management system and perform one or more functions when a processor executes the software associated with the service. In some examples, a service is a program, or a collection of programs that carry out a specific function. In some examples, a service can be considered a server. The memory can be a non-transitory or transitory computer-readable medium.

In some examples, the computer-readable storage devices, mediums, and memories can include a cable or wireless signal containing a bit stream and the like. However, when mentioned, transitory computer-readable storage media are media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, solid state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

Having now fully set forth examples and certain modifications of the concept underlying the present disclosure, various other examples as well as certain variations and modifications of the examples herein shown and described will obviously occur to those skilled in the art upon becoming familiar with the underlying concept.

1-4. (canceled)

5. A computer-implemented method, comprising:
receiving, at a payment server from a first payment application associated with the payment server and executing on a first mobile device of a first user, a first request to transfer a stored value to a second user;
providing, by the payment server and via a second payment application associated with the payment server and executing on a second mobile device of the second user, an indication of the stored value for display on a user interface of the second payment application,
wherein the indication comprises a recommendation for converting the stored value to one or more alternate values, and
wherein the recommendation is based at least in part on transaction data associated with the second user;
receiving, at the payment server and from the second payment application, a second request to convert the stored value to the one or more alternate values for associating with a second user account of the second user,
wherein the second user account is stored in a data store maintained by the payment server;
upon receiving the second request, converting, by the payment server, the stored value to the one or more alternate values,
wherein the stored value is converted to the one or more alternate values using a ledger architecture of a payment service associated with the payment server, and
wherein the ledger architecture comprises a plurality of ledgers comprising a respective ledger for each of the stored value and the one or more alternate values; and
facilitating, by the payment server, a transfer of the one or more alternate values to the second user account associated with the second user.

6. The computer-implemented method of claim 5, further comprising:
identifying, by the payment server and in the transaction data, transaction activity associated with the second user;
determining, by the payment server, a probability map indicative of at least one of the one or more alternate values most correlated to the transaction activity associated with the second user;
determining, by the payment server, the recommendation based on the probability map; and
sending, by the payment server, a selection request to the second payment application executing on the second mobile device, wherein the selection request comprises the recommendation.

7. The computer-implemented method of claim 6, wherein the recommendation further comprises a reward value, wherein the reward value comprises one or more second alternate values.

8. The computer-implemented method of claim 5, wherein facilitating the transfer of the one or more alternate values further comprises:
debiting, by the payment server, the stored value from a first user account associated with the first user; and
crediting, by the payment server, the one or more alternate values to the second user account.

9. The computer-implemented method of claim 5, wherein facilitating the transfer of the one or more alternate values further comprises:
crediting, by the payment server, the stored value to a stored value account of the payment service; and
debiting, by the payment server, the one or more alternate values from an alternate value account of the payment service.

10. (canceled)

11. The computer-implemented method of claim 5, further comprising:
sending, by the payment server, a receipt to one or more of the first payment application executing on the first mobile device and the second payment application executing on the second mobile device, wherein the receipt comprises information associated with the transfer of the one or more alternate values.

12. The computer-implemented method of claim 5, wherein the stored value and the one or more alternate values comprise one or more of equity, cryptocurrency, fiat currency, merchant credit, merchant discount, product discount, service discount, or any portion thereof.

13. A non-transitory computer-readable medium storing instructions that, when executed by one or more processors of a payment server, are operable to cause the one or more processors to perform operations comprising:
receiving, at the payment server from a first payment application associated with the payment server and executing on a first mobile device of a first user, a first request to transfer a stored value to a second user;
providing, by the payment server and via a second payment application associated with the payment server and executing on a second mobile device of the second user, an indication of the stored value for display on a user interface of the second payment application,
wherein the indication comprises a recommendation for converting the stored value to one or more alternate values, and
wherein the recommendation is based at least in part on transaction data associated with the second user;
receiving, at the payment server and from the second payment application, a second request to convert the stored value to the one or more alternate values for associating with a second user account of the second user,
wherein the second user account is stored in a data store maintained by the payment server;
upon receiving the second request, converting, by the payment server, the stored value to the one or more alternate values,
wherein the stored value is converted to the one or more alternate values using a ledger architecture of a payment service associated with the payment server, and
wherein the ledger architecture comprises a plurality of ledgers comprising a respective ledger for each of the stored value and the one or more alternate values; and
facilitating, by the payment server, a transfer of the one or more alternate values to the second user account associated with the second user.

14. The non-transitory computer-readable medium of claim 13, the operations further comprising:
identifying, in the transaction data, transaction activity associated with the second user;
determining a probability map indicative of at least one of the one or more alternate values most correlated to the transaction activity associated with the second user;
determining the recommendation based on the probability map; and
sending a selection request to the second payment application executing on the second mobile device, wherein the selection request comprises the recommendation.

15. The non-transitory computer-readable medium of claim 14, wherein the recommendation further comprises a reward value, wherein the reward value comprises one or more second alternate values.

16. The non-transitory computer-readable medium of claim 13, wherein the operations for facilitating the transfer of the one or more alternate values further comprise:
debiting the stored value from a first user account associated with the first user; and
crediting the one or more alternate values to the second user account.

17. The non-transitory computer-readable medium of claim 13, wherein the operations for facilitating the transfer of the one or more alternate values further comprises:
crediting the stored value to a stored value account of the payment service; and
debiting the one or more alternate values from an alternate value account of the payment service.

18. (canceled)

19. The non-transitory computer-readable medium of claim 13, the operations further comprising:
sending a receipt to one or more of the first payment application executing on the first mobile device and the second payment application executing on the second mobile device, wherein the receipt comprises information associated with the transfer of the one or more alternate values.

20. The non-transitory computer-readable medium of claim 13, wherein the stored value and the one or more alternate values comprise one or more of equity, cryptocurrency, fiat currency, merchant credit, merchant discount, product discount, service discount, or any portion thereof.

21. The computer-implemented method of claim 5, wherein converting, by the payment server, the stored value to the one or more alternate values further comprises:
debiting the stored value from a first ledger of a first user account associated with the first user, wherein the first ledger is associated with the stored value;
crediting the stored value to a second ledger of the payment service associated with the stored value;
debiting the one or more alternate values from at least one third ledger of the payment service associated with the one or more alternate values; and
crediting the one or more alternate values to at least one fourth ledger of the second user account associated with the one or more alternative values.

22. A processing system comprising:
a processor; and
a memory in communication with the processor and comprising instructions which, when executed by the processor, program the processor to perform operations comprising:
receiving, at a payment server from a first payment application associated with the payment server and executing on a first mobile device of a first user, a first request to transfer a stored value to a second user;
providing, by the payment server and via a second payment application associated with the payment server and executing on a second mobile device of the second user, an indication of the stored value for display on a user interface of the second payment application,
wherein the indication comprises a recommendation for converting the stored value to one or more alternate values, and
wherein the recommendation is based at least in part on transaction data associated with the second user;
receiving, at the payment server and from the second payment application, a second request to convert the stored value to the one or more alternate values for associating with a second user account of the second user,
wherein the second user account is stored in a data store maintained by the payment server;
upon receiving the second request, converting, by the payment server, the stored value to the one or more alternate values,
wherein the stored value is converted to the one or more alternate values using a ledger architecture of a payment service associated with the payment server, and
wherein the ledger architecture comprises a plurality of ledgers comprising a respective ledger for each of the stored value and the one or more alternate values; and
facilitating, by the payment server, a transfer of the one or more alternate values to the second user account associated with the second user.

23. The processing system of claim 22, wherein the operations further comprise:
identifying, by the payment server and in the transaction data, transaction activity associated with the second user;
determining, by the payment server, a probability map indicative of at least one of the one or more alternate values most correlated to the transaction activity associated with the second user;
determining, by the payment server, the recommendation based on the probability map; and
sending, by the payment server, a selection request to the second payment application executing on the second mobile device, wherein the selection request comprises the recommendation.

24. The processing system of claim 23, wherein the recommendation further comprises a reward value, wherein the reward value comprises one or more second alternate values.

25. The processing system of claim 22, wherein facilitating the transfer of the one or more alternate values further comprises:
debiting, by the payment server, the stored value from a first user account associated with the first user; and
crediting, by the payment server, the one or more alternate values to the second user account.

26. The processing system of claim 22, wherein facilitating the transfer of the one or more alternate values further comprises:
crediting, by the payment server, the stored value to a stored value account of the payment service; and
debiting, by the payment server, the one or more alternate values from an alternative value account of the payment service.
